(19) United States
(12) Patent Application Publication
(10) Pub. No.: US 2004/0119267 A1
(43) Pub. Date: Jun. 24, 2004

(54) Natural fiber tether for an airbag system

(75) Inventors: Glenn A. Cowelchuck, Chesterfield, MI (US); Michael J. Hier, Royal Oak, MI (US)

Correspondence Address: BROOKS KUSHMAN P.C. / LEAR CORPORATION, 1000 TOWN CENTER, TWENTY-SECOND FLOOR, SOUTHFIELD, MI, 48075-1238, US

(73) Assignee: Lear Corporation, Southfield, MI (US)

(21) Appl. No.: 10/325,263

(22) Filed: Dec. 19, 2002

(51) Int. Cl. B60R 21/20

(52) U.S. Cl. 280/728.3

(57) ABSTRACT

A vehicle airbag system includes a panel having a breakaway door, and an airbag housing that extends behind the breakaway door. An inflatable airbag cushion and an inflator are disposed within the airbag housing, and the inflator is operable to inflate the airbag cushion. The system also includes a tether having a first portion attached to the breakaway door of the panel and a second portion attached to at least one of the panel and the airbag housing. Furthermore, the tether comprises natural fibers.

### BACKGROUND OF THE INVENTION

1. Field of the Invention

The present invention relates to a vehicle airbag system having a flexible tether.

2. Background Art

Various airbag systems have been developed for use with motor vehicles. One known system, for example, includes a housing attached to an instrument panel behind a breakaway door, an airbag disposed within the housing, and an inflator attached to the airbag for inflating the airbag. The system further includes a plastic hinge member or tether connected between the housing and the instrument panel. The tether functions to retain the breakaway door during deployment of the airbag.

### SUMMARY OF THE INVENTION

Under the invention, a vehicle airbag system includes a panel having a breakaway door, and an airbag housing that extends behind the breakaway door. An inflatable airbag cushion and an inflator are disposed within the airbag housing, and the inflator is operable to inflate the airbag cushion. The system also includes a tether having a first portion attached to the breakaway door of the panel and a second portion attached to at least one of the panel and the airbag housing. Furthermore, the tether comprises natural fibers.

In one embodiment of the invention, the natural fibers of the tether are woven to form a fabric layer. Additionally, the tether may include synthetic fibers interwoven with the natural fibers.

The tether may also be configured in a layered construction that extends from the first end to the second end. The layered construction may include, for example, the above described fabric layer disposed between two plastic layers. The plastic layers of this layered construction may comprise thermoplastic urethane.

Further under the invention, a trim panel for use with a motor vehicle includes a trim panel body having a breakaway door configured to extend over an area that receives an airbag, and a tether having one end attached to the breakaway door. Furthermore, the tether comprises natural fibers.

### BRIEF DESCRIPTION OF THE DRAWINGS

FIG. 1 is a cross-sectional view of an airbag system with two tethers according to the invention;

FIG. 2 is a cross-sectional view of the system of FIG. 1, showing an airbag of the system in a deployed position;

FIG. 3 is an enlarged, fragmentary cross-sectional view of a portion of one of the tethers showing one exemplary construction; and

FIG. 4 is a cross-sectional view of a second embodiment of an airbag system with two tethers according to the invention.

### DETAILED DESCRIPTION OF THE PREFERRED EMBODIMENTS

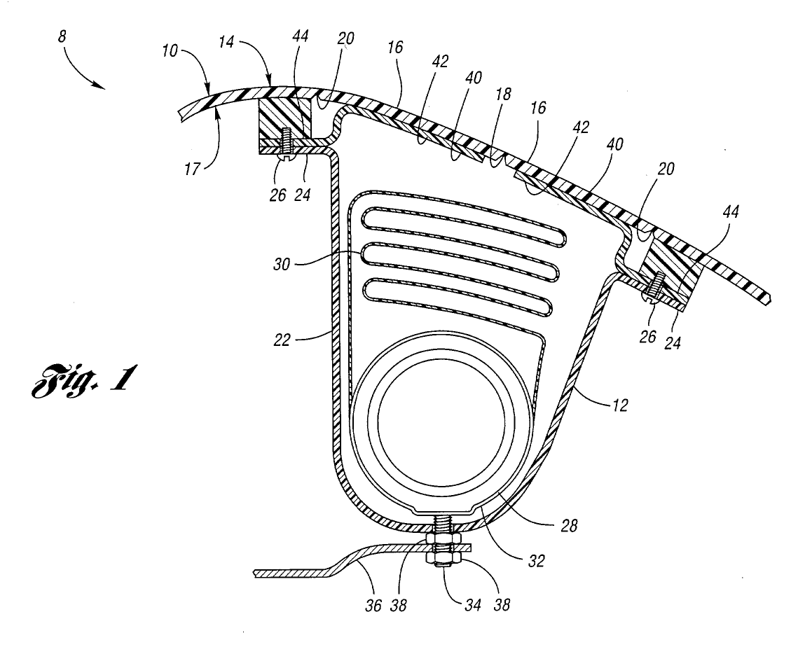

FIG. 1 shows an airbag system 8 for use with a vehicle (not shown). The system 8 includes an interior trim panel 10 and an airbag assembly 12 attached to the panel 10. The panel 10 may be any suitable interior trim panel, such as an instrument panel, door panel, headliner, knee bolster panel or the like, and includes a panel body having an exterior surface 14 that faces a passenger compartment of the vehicle. Moreover, the panel 10 may include a single layer or multiple layers, such as a substrate layer and outer skin layer. A foam layer may also be provided between the substrate layer and skin layer if desired.

The panel 10 also includes one or more breakaway doors 16 that are configured to open when the airbag assembly 12 is actuated or otherwise deployed. In the embodiment shown in FIG. 1, the panel 10 includes two breakaway doors 16. The breakaway doors 16 may be formed, for example, by scoring an interior surface 17 of the panel 10 to form one or more score lines 18 and 20. The score lines 18 (only one score line is shown in FIG. 1) may function as tear lines or seams that separate when the air bag assembly 12 is deployed, and the score lines 20 may function as bend or hinge lines about which the breakaway doors 16 may pivot. Additional score lines 18 (not shown) are also provided along the sides of the breakaway doors 16 such that the score lines 18 cooperate to define an H-shaped tear seam. If the panel 10 is provided with a single breakaway door 16, then the score lines 18 may cooperate to define a U-shaped tear seam. The score lines 20 may also be configured to tear or otherwise separate during deployment of the air bag assembly 12. As another example, the breakaway doors 16 may be formed by stamping, milling, molding, or otherwise forming hinge lines and/or tear lines or seams having any suitable configuration.

Continuing with FIG. 1, the airbag assembly 12 includes an airbag housing 22 that extends behind the breakaway doors 16. While not required, in the embodiment shown in FIG. 1, the housing 22 is mounted to the panel 10. More specifically, the housing 22 includes one or more connection flanges, such as a peripheral connection flange 24, connected to the panel 10 with fasteners 26. Alternatively, the housing 22 may be connected to the panel 10 in any suitable manner. For example, the connection flange 24 may be welded or adhesively attached to the panel 10. Examples of suitable welding techniques include vibration welding and sonic welding. Furthermore, the housing 22 may be made of any suitable material such as metal or plastic.

The airbag assembly 12 also includes an airbag inflator 28 and an inflatable airbag 30 disposed within the housing 22. In the embodiment shown in FIG. 1, the inflator 28 is mounted to the housing 22. More specifically, the inflator 28 includes an inflator body 32 and one or more threaded studs 34 welded or otherwise connected to the inflator body 32. Each stud 34 extends through a corresponding aperture in the housing 22, and the studs 34 may be connected to a support bracket 36 that is connected to a support structure, such as a cross-car beam (not shown). Threaded nuts 38 may be used to connect the studs 34 to the housing 22 and to the support bracket 36. Alternatively, the inflator 28 may be secured to the housing 22 in any suitable manner.

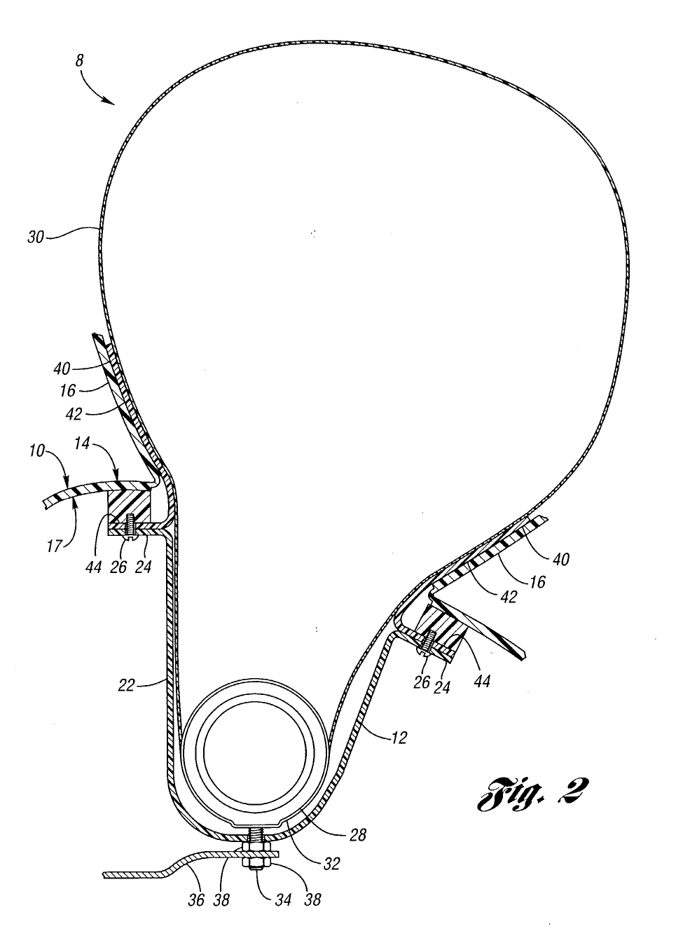

The airbag 30 is connected to or otherwise in fluid communication with the inflator 28, which is operative to inflate the airbag 30 when actuated by an actuating device (not shown). When inflated, the airbag 30 expands from a stored position, illustrated in FIG. 1, to a deployed position, shown in FIG. 2. Furthermore, the airbag 30 may be constructed from any suitable material, including woven nylon or a non-woven material such as plastic film.

The airbag assembly 12 also includes one or more flexible tethers 40 connected to the panel 10. In the embodiment shown in FIGS. 1 and 2, the airbag assembly 12 includes two tethers 40. Each tether 40 includes a first portion or end 42 secured to a respective breakaway door 16, and a second portion or end 44 that is secured to another structure. Each first end 42 may be connected to a respective breakaway door 14 in any suitable manner, such as with fasteners and/or adhesive, in one embodiment of the invention, each first end 42 is welded to a respective breakaway door 14, such as by a vibration or sonic welding technique. According to another embodiment of the invention, the first ends 42 of the tethers 40 may be secured to the breakaway doors 16 by an insert molding process. More specifically, for example, the tethers 40 may be partially or fully inserted into a mold into which plastic is injected to form the panel 10. As a result, the panel 10 may be simultaneously formed and attached to the tethers 40.

In the embodiment shown in FIGS. 1 and 2, each second end 44 is secured between the connection flange 24 and the panel 10 by the fasteners 26. Alternatively, the second ends 44 may be secured to the panel 10, housing 22, or any other suitable structure in any suitable manner. For example, the second ends 44 may be attached to the panel 10 and/or housing 22 with adhesive, a vibration or sonic welding technique, or insert molding process.

Each tether 40 functions to retain a respective breakaway door 16 during deployment of the airbag 30, so as to inhibit the breakaway doors 16 from separating from the remainder of the system 8 even if the score lines 20 tear or otherwise separate. As illustrated in FIG. 2, each tether 40 remains secured between a respective breakaway door 16 and the airbag housing 22 when the airbag 30 is in the deployed position. Each tether 40 may also function as a hinge that allows or facilitates the pivotal movement of the respective breakaway door 16 during deployment of the airbag 30. The first end 42 of each tether 40 may also be attached to a respective door 16 at multiple locations such that each tether 40 is attached to a respective door 16 substantially along the entire portion of the tether 40 that is positioned adjacent to the respective door 16.

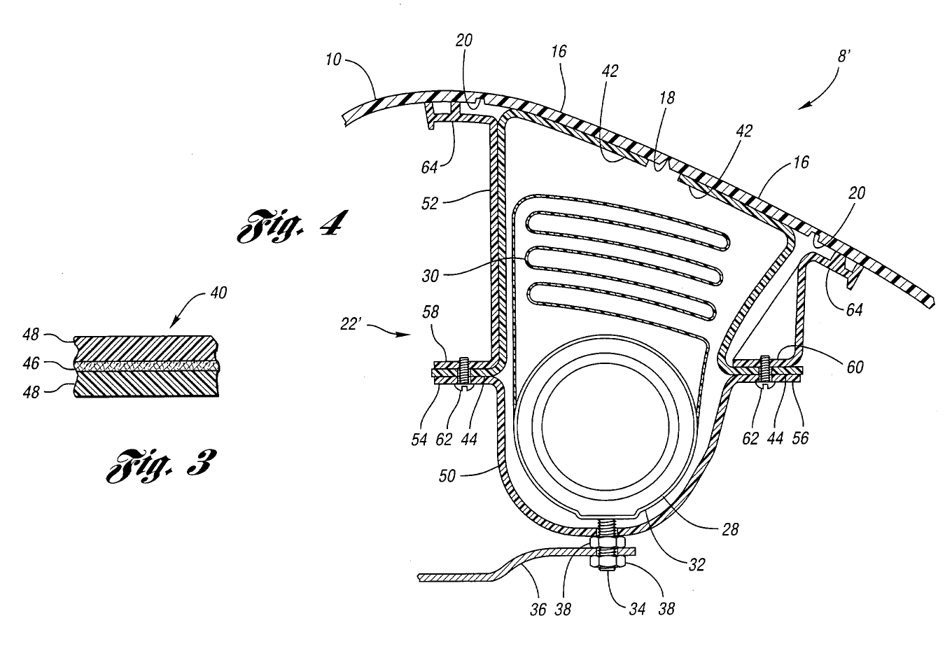

In accordance with the invention, each tether 40 includes natural fibers arranged in any suitable configuration. Referring to FIG. 3, for example, each tether 40 may include natural fibers that are woven together to form a fabric layer, such as a scrim layer 46. Furthermore, the natural fibers may comprise any suitable fibers, such as flax, hemp, jute and/or cotton. Synthetic fibers, such as polyester, polypropylene and/or nylon fibers, may also be interwoven with the natural fibers to form the scrim layer 46. Moreover, the scrim layer 46 may be coated with plastic, such as polyester or polyurethane.

Still referring to FIG. 3, each tether 40 may include a layered construction. For example, each tether 40 may include the scrim layer 46 disposed between two layers of plastic 48, such as thermoplastic elastomer or thermoplastic urethane. As another example, each tether 40 may include scrim layer 46 extruded within a layer of plastic, such as thermoplastic elastomer or thermoplastic urethane, such that the scrim layer 46 is surrounded by the layer of plastic. Such a construction may extend the full length of each tether 40, or only along a portion of each tether 40, such as at one or both ends 42 and 44 of each tether 40.

Because the tethers 40 are made with natural fibers, the tethers 40 may be less expensive to manufacture than tethers that include only plastic fibers and/or other plastic layers. Furthermore, the inclusion of natural fibers may result in the tethers 40 having greater strength than prior tethers.

Referring now to FIG. 4, a second embodiment 8′ of an airbag system is illustrated. The system 8′ is similar to the system 8 and includes many of the same or similar features, which are identified with the same reference numbers. The system 8′, however, includes a housing 22′ having first and second housing portions, such as lower and upper housing portions 50 and 52, respectively. The lower housing portion 50 includes first and second connection flanges 54 and 56, respectively, that are respectively positioned adjacent to first and second connection flanges 58 and 60, respectively, of the upper housing portion 52. The connection flanges 54 and 56 of the lower housing portion 50 may be connected to the connection flanges 58 and 60 of the upper housing portion 52 by multiple spaced apart fasteners 62, such as screws or bolts, that extend through corresponding apertures in the housing portions 50 and 52. The upper housing portion 52 further includes one or more additional connection flanges, such as a peripheral connection flange 64, connected to panel 10. For example, the connection flange 64 may be welded and/or adhesively attached to the panel 10 away from break away doors 16. Examples of suitable welding processes include vibration welding and sonic welding. Alternatively, the connection flange 64 may be attached to the panel 10 in any suitable manner, such as with fasteners.

Because the housing 22′ includes two portions 50 and 52 that are connected together, the two portions 50 and 52 may be made of different materials. For example, lower housing portion 50 may be made of metal, and upper housing portion 52 may be made of plastic. Alternatively, the portions 50 and 52 may be made of any suitable material or materials.

Similar to the system 8, the system 8′ includes two tethers 40 that each have a first end 42 attached to a respective breakaway door 16. For the system 8′, however, each tether 40 has a second end 44 that is secured between a respective pair of connection flanges 54 and 58, or 56 and 60. One or more fasteners 62 may also extend through the second end 44 of each tether 40 to further secure the tethers 40 between the connection flanges 54 and 58, or 56 and 60.

Like the system 8, the system 8′ may be provided with any suitable number of breakaway doors 16 and any suitable number of tethers 40. Furthermore, if only one breakaway door 16 is provided, then only one tether 40 may be required.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A vehicle airbag system comprising:
a panel having a breakaway door:
an airbag housing that extends behind the breakaway door;
an inflatable airbag cushion disposed within the airbag housing;
an inflator disposed within the airbag housing and being operable to inflate the airbag cushion; and
a tether having a first portion attached to the breakaway door of the panel and a second portion attached to at least one of the panel and the airbag housing, the tether comprising natural fibers.

2. The airbag system of claim 1 wherein the first portion of the tether is attached to the breakaway door by an insert molding process.

3. The airbag system of claim 1 wherein the first portion of the tether is welded to the breakaway door.

4. The airbag system of claim 1 wherein the tether further comprises at least one layer of thermoplastic urethane.

5. The airbag system of claim 1 wherein the natural fibers are woven to form a fabric layer, and wherein the tether comprises a layered construction that includes the fabric layer disposed between two plastic layers.

6. The airbag system of claim 5 wherein the plastic layers comprise thermoplastic urethane.

7. The airbag system of claim 5 wherein the tether includes synthetic fibers interwoven with the woven natural fibers.

8. The airbag system of claim 1 wherein the tether includes synthetic fibers interwoven with the natural fibers.

9. The airbag system of claim 1 wherein the natural fibers comprise flax.

10. The airbag system of claim 1 wherein the natural fibers comprise hemp.

11. The airbag system of claim 1 wherein the panel is an instrument panel.

12. A trim panel for use with a motor vehicle, the trim panel comprising:
a trim panel body having a breakaway door configured to extend over an area that receives an airbag; and
a tether having a portion attached to the breakaway door, the tether comprising natural fibers.

13. The trim panel of claim 12 wherein the natural fibers are woven to form a fabric layer, and wherein the tether comprises a layered construction that includes the fabric layer disposed between two plastic layers.

14. The trim panel of claim 13 wherein the plastic layers comprise thermoplastic urethane.

15. The trim panel of claim 12 wherein the tether further comprises synthetic fibers interwoven with the natural fibers.

16. The trim panel of claim 12 wherein the natural fibers comprise flax.

17. The trim panel of claim 12 wherein the natural fibers comprise hemp.
